(19) United States
(12) Patent Application Publication
(10) Pub. No.: US 2006/0049202 A1
(43) Pub. Date: Mar. 9, 2006

(54) Tablet dispenser

(76) Inventors: Martin Presche, Lohne (DE); Bernd Schreckenberg, Lohne (DE)

Correspondence Address: FRIEDRICH KUEFFNER, 317 MADISON AVENUE, SUITE 910, NEW YORK, NY, 10017, US

(21) Appl. No.: 10/537,229

(22) PCT Filed: Mar. 11, 2004
(86) PCT No.: PCT/EP04/02474

§ 371 Date: Jun. 3, 2005

(30) Foreign Application Priority Data
Mar. 14, 2003 (DE) 20304148.8

(51) Int. Cl. B65G 59/00; B65H 3/00; G07F 11/16

(52) U.S. Cl. 221/252

(57) ABSTRACT

The invention relates to a tablet dispenser (1) for holding a large number of tablets (2) and for dispensing them one by one. The tablet dispenser is comprised of: a two-part dispenser housing consisting of two housing halves (10; 20) of the same length, which are assembled to form a box; a housing bottom part (10) with a dispensing opening (3), which is made in the sidewall (14) of a corner of the housing and via which the tablets (2) are individually dispensed from the dispenser housing, and; a housing top part (20) that does not have an end wall (23) on the side from which the tablets are dispensed. The housing parts are joined to one another in a manner that enables them to be displaced parallel to the container axis in opposite directions during which the dispensing opening (3) of the housing bottom part (10) is alternately opened and closed by the housing upper part (20). In order to dispense only one tablet (2′) at a time while preventing an unintentional following of additional tablets (2), dosing elements are provided inside the dispenser housing that consist of a dead space barrier (11), which is mounted on the housing bottom part (10) at the corner opposite the dispensing opening (3), and of a barrier (21) that prevents tablets from following a single tablet to be dispensed, which is mounted on the housing top part (20) at the front end thereof. The dosing elements (11; 21) are designed and arranged so that they can be displaced relative to one another in such a manner that with each displacement travel of the housing halves (10; 20), only one tablet (2′) at a time reaches the dispensing area of the dispensing opening (3).

The invention relates to a tablet dispenser for holding and dispensing tablets one by one comprising a two-part dispenser housing for housing a large number of tablets with a dispensing opening arranged in the dispenser housing via which the tablets are dispensed individually from the dispenser housing.

In known tablet dispensers of simple construction, after opening the dispensing opening which for example closes a removal duct, the product contained in the container is able to move down, whereby an uncontrolled amount of the product is unintentionally released from the container.

In addition, dispensers with a mechanically operated device arranged in the dispensing housing are known. By means of the restricted-travel displacement of this device, the dispensing opening in the dispenser housing is cleared and one tablet per displacement is dispensed from the dispenser housing. Such a tablet dispenser is described in German Patent DE 29 22 350 A1. It comprises two telescopically adjustable housing parts, which each have a dispensing opening at their long sides and which are arranged displaced relative to each other in the starting position. By means of external pressure on the protruding end of the inner housing piece which serves as an actuating button it is shifted further into the outer housing piece, whereby both dispensing openings are aligned and a tablet is dispensed. A finger of the housing inner piece is simultaneously is shifted with the shifting and prevents that no more than one tablet is dispensed. A disadvantage of this dispenser is the fact that the protruding end of the inner housing piece does not eliminate an unintentional activation of the dispensing mechanics with sufficient certainty.

A tablet dispenser is known from European Patent EP 0 161 538 B1 in which two telescoping housing pieces also comprise a dispenser housing, wherein a spring arranged on the inner housing piece in the shape of a tongue supports itself at the wall of the outer housing piece. Both housing pieces are designed such that a dispensing chamber with a diagonally descending sorting groove is formed when slid together. The width of the sorting groove matches the thickness of the horizontal tablet position and the dispensing chamber is dimensioned such that there are always at least two pre-sorted tablets arranged on top of each other and ready to be dispensed. During dispensing, in which again both housing openings are aligned by shifting both housing pieces, a partitioning finger is slid in between both tablets such that again only one tablet is dispensed.

A tablet dispenser is also known from the preamble of claim 1 in U.S. Pat. No. 2,502,311.

Based on this state of the art it is the object of the present invention to design a dispensing device of this category with simple construction and manufacturing means and without the aid of elaborate mechanical device such that, after opening of the dispensing opening only one tablet is dispensed and an unintentional following of additional tablets is prevented.

This object is met by means of a dispenser housing with the distinguishing characteristics of claim 1, comprising two housing halves of the same length which are assembled to form a box, a housing bottom part with a dispensing opening arranged in the corner of the housing, and a housing top part without a front wall at the dispensing side which are connected to each other in such a way that a displacement parallel to the container axis in opposite directions is possible which alternately opens and closes the dispensing opening in a corner of the housing base part's side wall by means of the housing top part.

The tablet dispenser according to the present invention works as follows: By holding the tablet dispenser at an angle with the dispensing corner as the lowest point the tablets descend to this dispensing corner. By sliding back the housing top part and thereby clearing the lateral dispensing opening in the side wall of the housing base, exactly only one tablet remains in the dispensing corner while the other tablets are pushed back by dosing elements.

A dead storage barrier located in the interior of the dispenser housing on the housing bottom part at the corner opposite the dispensing opening and a chase barrier preventing the trailing of further tablets mounted on the housing top part at the front side are arranged as dosing elements according to the invention, so that only one tablet can enter the dispensing area at a time and that the tablet is partitioned off from other trailing tablets when the dispensing opening is open.

The chase barrier on the housing top part is nose-shaped with a wider back projecting toward the dispensing side in steps. The chase barrier is arranged within the interior of the dispenser housing such that the lateral distance of the wider back to the side wall of the dispenser housing top part located at the dispensing side is larger than, and the distance to the side wall of the dispensing housing bottom part located at the dispensing side is smaller than the diameter of a tablet. This arrangement of the chase barrier makes it possible that exactly only one tablet has room in front of the closed dispensing opening between the side wall located at the dispensing side of the housing top part and the back of the chase barrier in the closed state of the tablet dispenser and which can be dispensed when opening the dispensing opening by displacing of the housing top part. Subsequent tablets are on the other hand pushed back by this displacement, since the space between the back of the chase barrier and the side wall of housing bottom part is not sufficiently big enough for a tablet to fit.

The shape and size of the chase barrier may be adapted to various sizes and shapes of tablets by means of a corresponding design and arrangement on the housing top part.

The dead storage barrier located in the interior of the housing is mounted at the corner of the housing bottom part located opposite the dispensing opening such that it fills the space between the chase barrier and the side wall of the housing bottom part in a starting position of the tablet dispenser, and is displaced in the starting position of the tablet dispenser relative to the chase barrier such that it advantageously prevents an otherwise possible trail of tablets around the front of the chase barrier.

In tablet dispensers for flat tablets whose thickness is substantially smaller than housing depth of the tablet dispenser so that two or more tablets can lie on top of each other, an additional ramp-like dosing element is mounted on the housing bottom part for pre-dosing the tablets in the housing corner in the interior of the dispenser housing in the intake area toward the dispensing opening. For manufacturing reasons, this ramp-like dosing element is—usually such a tablet dispenser is injection-molded—concavely shaped as seen from the exterior of the housing exterior with stabilizing webs arranged in the cavity. These webs may then also serve as a backing for the adhesive surface of, for example a possible bottom label.

According to an advantageous embodiment of the present invention, both housing halves of the dispenser housing are at their long sides connected with each other by means of a detachable locking mechanism, for example, by means of a clip lock. Such a lock can easily be unlocked, for example, for refilling the tablet dispenser when empty.

In order to facilitate the assembly of the housing top part after filling the housing bottom part, the front wall of the bottom housing part located at the dispensing side exhibits, according to another advantageous embodiment of the invention, a recess which corresponds to the width of the wide back of the chase barrier. This makes it more easily possible to mount the housing top part on the housing bottom part in a direction opposite the dispensing direction and connect both housing parts to each other, without the filling material getting trapped between the dosing elements of the housing top and bottom parts which would significantly complicate the assembly. The resulting gap is then closed by sliding the wide back of the chase barrier into this recess when the tablet dispenser is closed.

In order to prevent the housing top part from being displaced too far, the shifting path of the housing top part is restricted according to the invention. For this purpose a cam is arranged on the top surface of the housing top part which in an end position abuts the rear front wall of the housing bottom part located opposite the dispensing opening and thus blocks any further displacement. Furthermore, an arched web is arranged on the top surface inside the housing top part which drags across the dead storage barrier during the shifting of the housing top part, thereby hampering an unintentional opening or closing of the tablet dispenser and signalling an opening and closing with a sound and/or tactile sensation. All dosing elements arranged in the interior of the housing as well as the restricting-displacement cam and the web which hampers and signals the opening and closing are all manufactured in one piece together with the respective housing part.

In order to facilitate a closing of the tablet dispenser after the dispensing of a tablet, a resetting device with a spring element is arranged in the area of the housing top part opposite the dispensing opening which supports itself at the rear front wall of the housing bottom part.

When the housing top part is displaced for the dispensing of a tablet this spring is stretched and then, following the dispensing of the tablet, effects a facilitated repositioning of the housing top part into the starting position. When installing the spring it can be pretensioned such that the elastic force is sufficiently strong to enable an automatic closing of the tablet dispenser. Either a spring bar subject to bending stress or a spiral spring subject to compression loading can for example be used as a spring element.

For better handling of the tablet dispenser, the top part exhibits a recess located at the front wall opposite the dispensing opening as a further advantageous embodiment of the invention. The front wall of the housing bottom part is accessible from the outside through this recess, which makes it possible to facilitate the displacement of the housing halves by for example applying pressure on this front wall with a finger.

Further details, embodiments and advantages of the invention will result from the following description of the drawings, wherein:

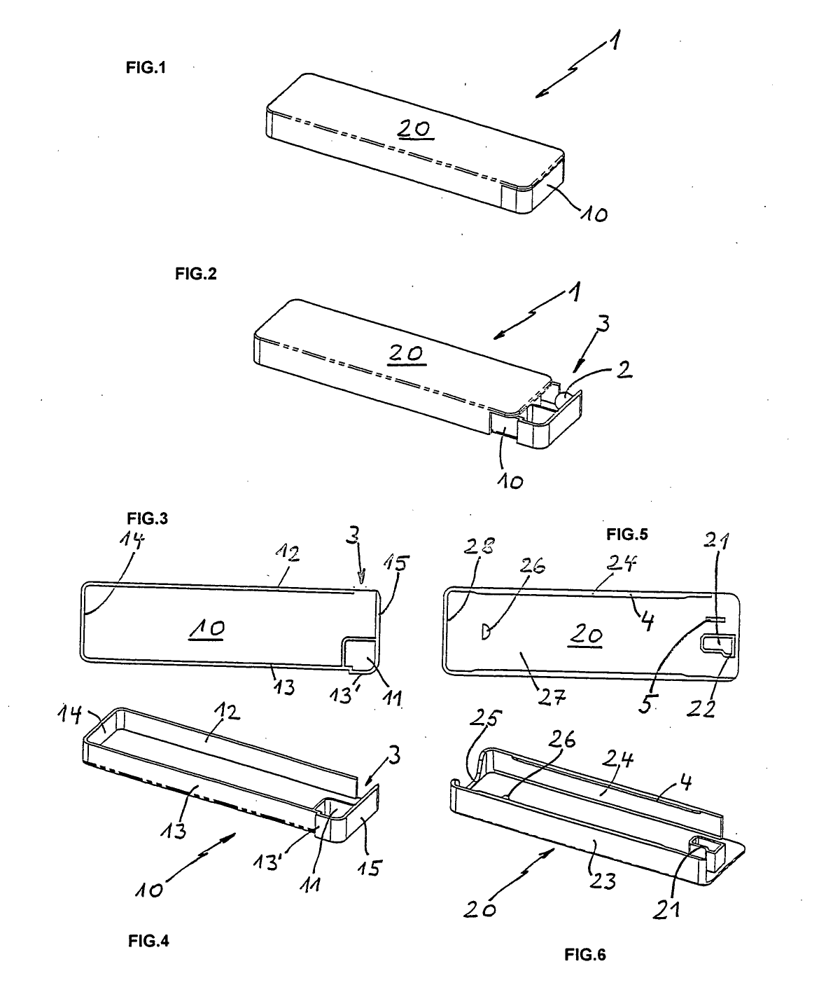

FIGS. 1 and 2 are foreshortened views of a tablet dispenser in the starting position and in the dispensing position;

FIGS. 3 to 6 are different views of the housing parts of the tablet dispenser shown in FIGS. 1 and 2;

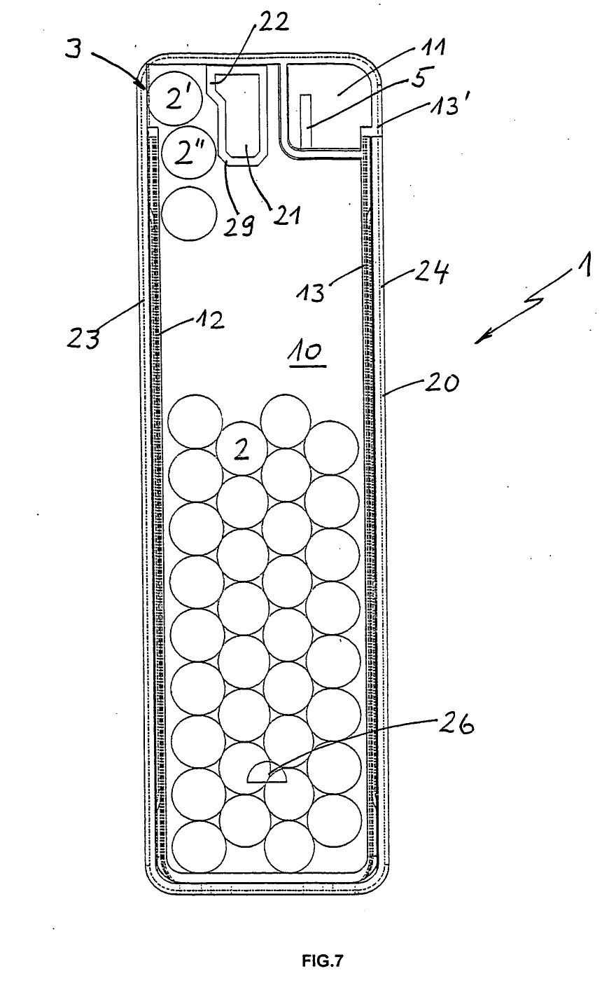

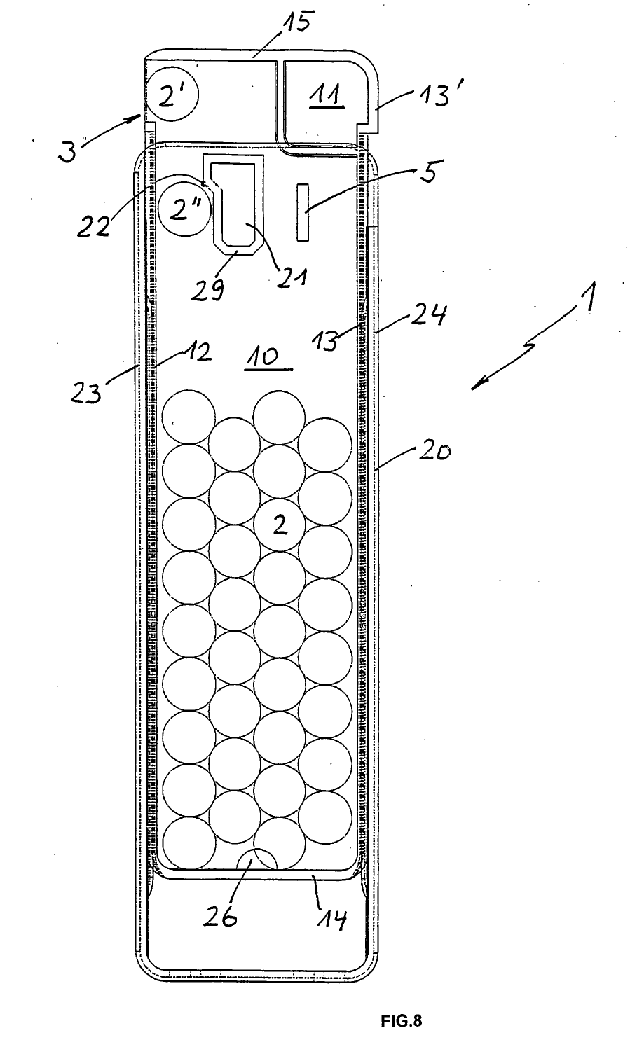

FIG. 7 is a horizontal sectional view of the tablet dispenser of FIGS. 1 and 2;

FIG. 8 is a view of the tablet dispenser shown in FIG. 7 in the dispensing position;

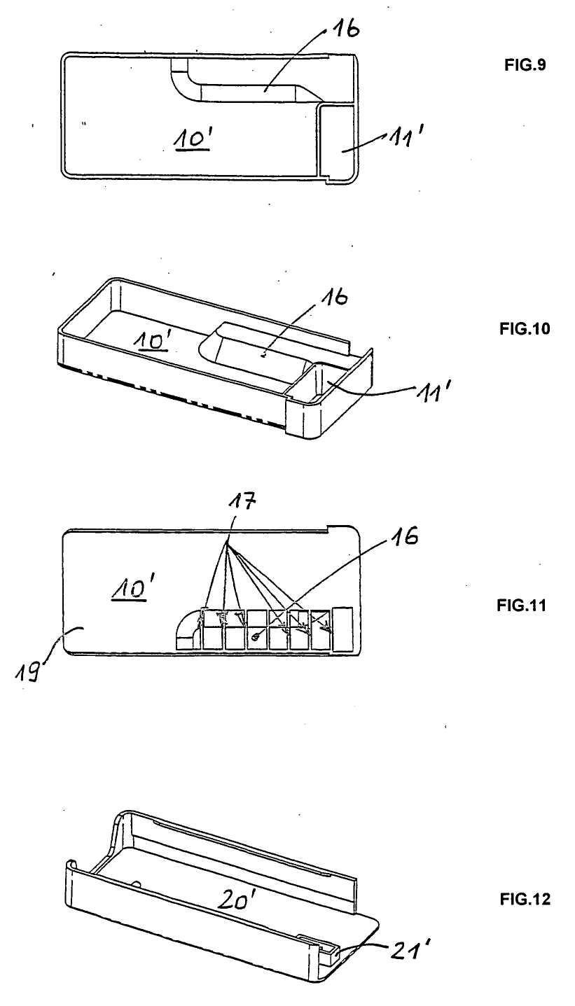

FIGS. 9 to 12 are different views of the housing parts of an additional tablet dispenser;

FIGS. 13 to 16 are different views of the housing parts of a third tablet dispenser;

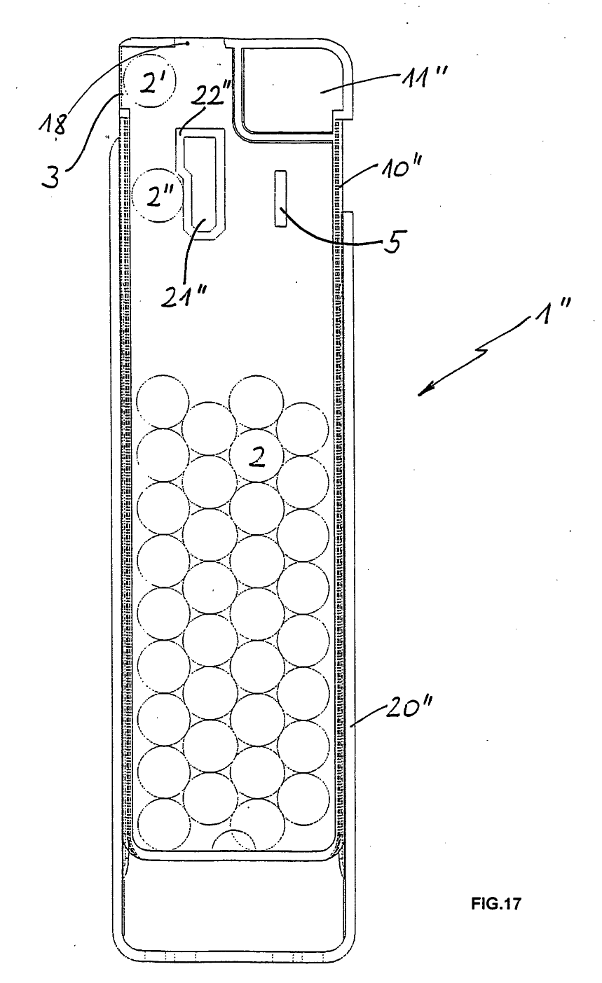

FIG. 17 is a horizontal sectional view of a tablet dispenser with the housing parts shown in FIGS. 13 to 16 in a starting position;

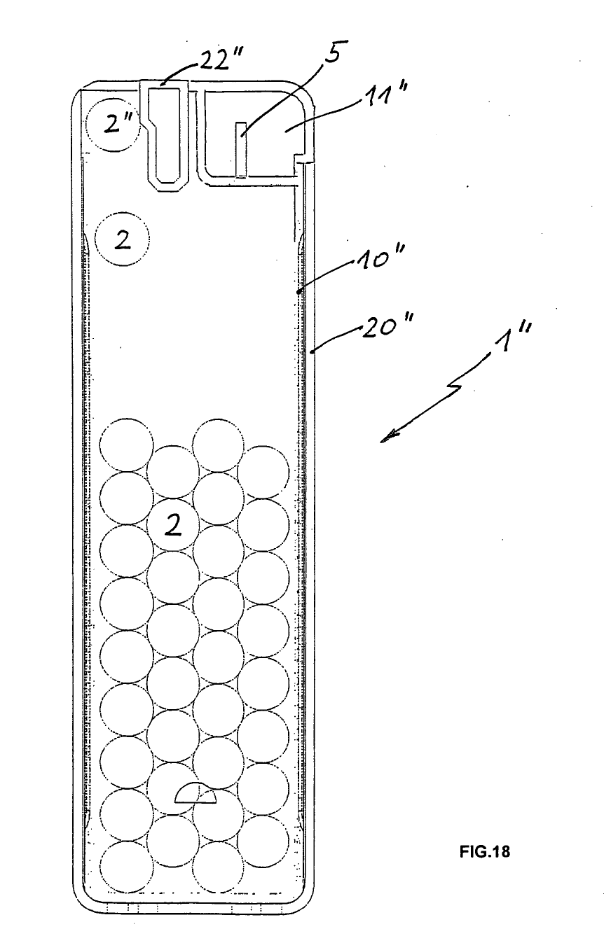

FIG. 18 is a view of the tablet dispenser shown in FIG. 17 in the dispensing position, and

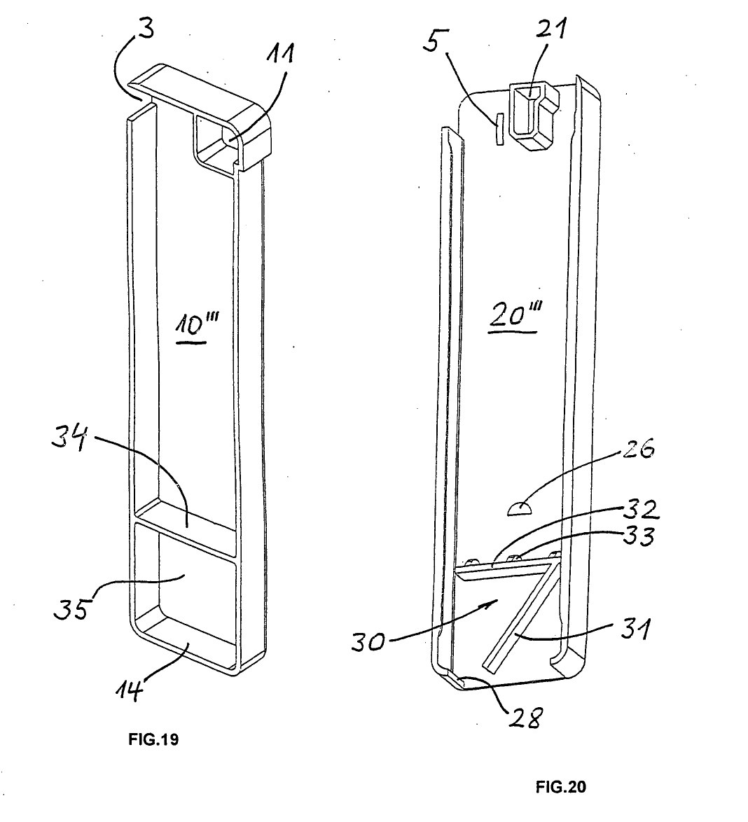

FIGS. 19 and 20 show housing parts of a fourth tablet dispenser with a spring element.

The tablet dispenser 1 according to FIGS. 1 and 2 is boxed-shaped with a container depth corresponding to the tablet height. In the dispensing position shown in FIG. 2 the housing top part 20 is pushed back far enough relative to the housing bottom part 10 that the dispensing opening 3 at the side of the housing bottom part 10 is just cleared and one tablet 2 can be dispensed.

FIGS. 3 to 6 show both housing parts which together make up the tablet dispenser 1 in both a top view (FIGS. 3 and 5) and foreshortened view (FIGS. 4 and 6). The housing parts consist of a housing bottom part 10 and a housing top part 20 which are both shaped like drawers and form the tablet dispenser 1 shown in FIGS. 1 and 2 when sliding their side walls 12, 13 and 23, 24 over one another, wherein a snap-on connection 4 prevents both housing pieces from falling apart after assembly without blocking any intentional displacement.

In order to enable a displacement of the housing top part 20 according to FIG. 2, only the housing bottom part 10 has a fore front wall 15, while the housing top part 20 lacks such a wall. In order to restrict the displacement of the housing upper part 20 and prevent both housing parts from being completely pushed apart, the housing top part 20 has a cam 26 in the back area of its top surface 27 which abuts the rear front wall 14 of the housing bottom part 10 during the displacement of the housing top part 20 and thus blocks any further displacement.

An arched web 5 is arranged on the inside top surface 27 of the housing top part 20 next to the chase barrier 21 which drags across the dead storage barrier 11 of the housing bottom part 10 when displacing the housing top part 20. The height of the web 5 is high enough that the web 5 hampers the unintentional opening and closing of the tablet dispenser 1 and produces an audible or tactile clicking sensation when opening and closing.

When restoring the starting position by pushing back housing top part 20, the dispensing opening 3 in the side wall 12 of the housing bottom part 10 is closed off again by the side wall 23 of the housing top part 20, while the opposing shortened side wall 24 of the housing top part 20 tightly abuts the stepped protruding end 13′ which is designed as a stop in the side wall 13 of the housing bottom part 10. The front wall 28 of the housing top part 20 opposite the dispensing opening 3 exhibits a semicircular recess 25 in order to make the front wall 14 of the housing bottom part 10 accessible and thus make it easier to shift the housing bottom part 10 relative to the housing top part 20 into the dispensing position shown in FIG. 2.

In order to better separate the tablets 2 and to prevent an unintentional trail of further tablets 2 during the dispensing procedure, dosing elements are arranged in the interior of the housing on the housing top part 20 and on the housing bottom part 10. The housing bottom part 10 exhibits in this regard a dead storage barrier 11 opposite the dispensing opening 3 and the housing top part 20 has a chase barrier 21 arranged between the dispensing opening 3 and the dead storage barrier 11.

The effect of these dosing elements is made clear in FIGS. 7 and 8. In the starting position shown in FIG. 7 exactly one tablet 2′ is located at the dispensing opening 3 in the dispensing area of the tablet dispenser 1, while the remaining upper space is almost completed filled by the dead storage barrier 11 and the chase barrier 21. The chase barrier 21 has at its upper end a widened back 22 whose distance to the side wall 23 sealing off the dispensing opening 3 is large enough that exactly one tablet 2′ fits between this back 22 and the side wall 23. Below the back 22 there is a also a tablet 2″ which fits in the groove between the side wall 12 of the housing bottom part 10 and the opposing side surface of the narrower forepart 29 of the chase barrier 21.

In the dispensing position shown in FIG. 8 the housing top part 20 is pushed open relative to the housing bottom part 10 far enough that the cam 26 abuts the lower front wall 14 and the dispensing opening 3 is cleared by the pushing back of the side wall 23. During the effected displacement the tablet 2″ located in the groove between forepart 29 of the chase barrier 21 and the side wall 12 is simultaneously pushed down with the wider back 22 of the chase barrier 21, since the distance between the back 22 and the side wall 12 of the housing bottom part 10 is small enough that the tablet 2″ no longer fits. Thus, a trail of tablets through this narrow space is impossible. Also a trail of tablets around the front of the chase barrier 21 is prevented since this path is now closed off by the dead storage barrier 11.

The housing parts of a tablet dispenser are shown in FIGS. 9 to 12 whose housing depth is significantly larger than the thickness of a single tablet. For separating tablets a dosing element in the shape of a ramp 16 is arranged in the dispensing area which is manufactured in one piece with the housing bottom part 10′, in which for manufacturing reasons, this ramp 16 is hollow as seen from bottom side 19 of the housing bottom part 10′.

For stabilizing this cavity webs 17 are arranged at a distance from each other in this cavity as shown in FIG. 11 which provides a top view onto the bottom side 19 of the housing bottom part 10′. The dead storage barrier 11′ is widened as far as this ramp 16, while the chase barrier 21′ is now significantly narrower than in the previous illustrations.

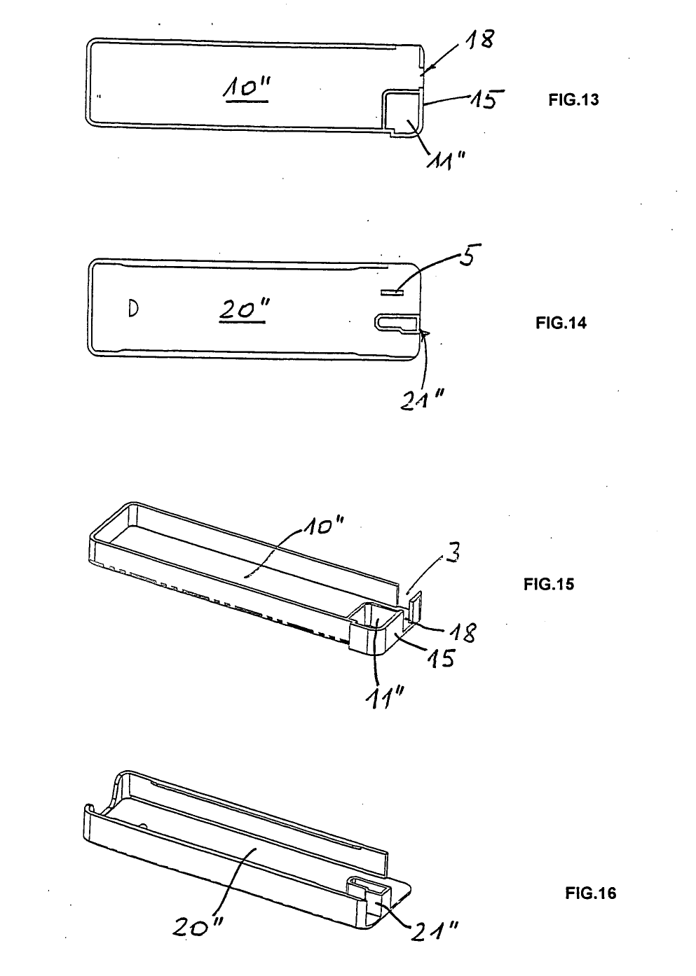

A tablet dispenser 1″ is shown in FIGS. 13 to 18 in which the housing parts have been modified for reasons of easier assembly. The housing bottom part 10″ exhibits in its fore front wall 15 a recess 18 whose width corresponds to the back width of the chase barrier 21″. In order that the chase barrier 21″ can completely fill with its wide back this recess in the front wall 15 of the housing bottom part 10″ in a starting position of the tablet dispenser 1″, the chase barrier 21″ on the housing top part 20″ is at the front edge thereof, as can be seen in FIGS. 14 and 16.

A tablet dispenser 1″ filled with tablets 2 is shown in FIGS. 17 und 18 in the starting position (FIG. 17) and in the dispensing position (FIG. 18), in which the chase barrier 21″ with an otherwise identical mode of operation as illustrated in FIGS. 1 to 8 can be seen arranged as far as the front edge of the housing bottom part 10″ and closing the recess 18 in the starting position of the tablet dispenser 1″. The width of the recess 18 in such a tablet dispenser 1″ must be smaller than a tablet diameter since a tablet could unwantedly be dispensed via the recess 18 as another dispensing opening. The housing parts 10′″ and 20′″ of a further (fourth) tablet dispenser are shown in FIGS. 19 and 20. In principle these housing parts 10′″ and 20′″ correspond to the housing parts 10 and 20 of the tablet dispenser 1 shown in FIGS. 1 to 8, but which in this case have been supplemented by a repositioning device with a spring element 30.

FIG. 19 shows a housing bottom part 10′″ corresponding to housing bottom part 10 with a stop wall 34 arranged at distance parallel to the rear front wall 14. A rear dead storage 35 is thus created in connection with the rear front wall 14 which cannot be filled with tablets, but instead serves to hold a spring element 30. This spring element 30 is shown in FIG. 20 which also shows the corresponding housing top part 20′″. It consists of a spring bar 31 which is diagonally angled and connected with one end to a spring web 32 as one piece. The spring web 32 is arranged at a distance to the rear front wall 28 in the housing top part 20′″ such that the free end of the spring web 32 is directed toward the rear front wall 28. In the starting position of the tablet dispenser with overlapping housing parts 10′″ and 20′″ this spring element 30 is positioned in the rear dead storage 35, in which the spring web 32 supports itself at the stop wall 34 and the free end of the spring web 32 abuts the rear front wall 14. During the displacement of the housing top part 20′″ in order to dispense a tablet, a forced bending of the spring bar 31 takes places which then guides the housing top part 20′″ back into the starting position following the completion of the dispensing procedure.

For facilitating the assembly and for properly spacing the spring web 32 relative to the stop wall 34, the bar side facing the stop wall 34 is designed with feeding ribs 33. A pretensioning of the spring bar 31 can be adjusted already in a starting position with an appropriate thickness selection of these feeding ribs 33.

The invention is not limited to the embodiments shown herein. Particularly with regard to shape and size of the chase barrier as well as the geometrical shape of the dispenser, an extensive adaptation is possible and necessary by an expert according to the size of the tablets contained in the dispenser or that of any other similar product such as, for example pellets.

| | |
|---|---|
| 1, 1″ | Tablet dispenser |
| 2, 2′, 2″ | Tablets |
| 3 | Dispensing opening |
| 4 | Snap-on connection |
| 5 | Web |
| 10, 10′, 10″, 10″′ | Housing bottom part |
| 11, 11′, 11″ | Dead storage barrier |
| 12 | Side wall (at the dispensing side) |
| 13 | Side wall |
| 13′ | Side wall projection |
| 14 | Front wall |
| 15 | Front wall (at the dispensing side) |
| 16 | Ramp-like dosing element |
| 17 | Webs |
| 18 | Recess |
| 19 | Housing bottom side |
| 20, 20′, 20″, 20″′ | Housing top part |
| 21, 21′, 21″ | Chase barrier |
| 22 | Back of 21 |
| 23 | Side wall (at the dispensing side) |
| 24 | Side wall |
| 25 | Recess |
| 26 | Cam |
| 27 | Top surface (inner surface of the top part) |
| 28 | Rear front wall |
| 29 | forepart of 21 |
| 30 | Spring element |
| 31 | Spring bar |
| 32 | Spring web |
| 33 | Feeding ribs |
| 34 | Stop wall |
| 35 | Rear dead storage |

1. A tablet dispenser for holding a large number of tablets and for dispensing them one by one, comprising two housing halves of the same length which are assembled on each other like a box; a housing bottom part with a dispensing opening arranged in the side wall for individual tablets and a housing top part without a front wall at the dispensing side with a chase barrier arranged in the interior of the dispensing housing at the front side, which are connected in such a way that enables them to be displaced parallel to the container axis in opposite directions, by means of this travel the dispensing opening is alternately opened and closed, wherein,
a) the chase barrier has a nose-shaped design with a wider back which protrudes in steps at the dispensing side and which is arranged such that its lateral distance to the side wall of the housing top part located at the dispensing side is larger than, and that to the side wall of the housing bottom part located at the dispensing side is smaller than the diameter of the tablets.
b) a dead storage barrier is arranged in the interior of the dispenser housing on the housing bottom part in the housing corner opposite the dispensing opening.
c) the dead storage barrier and the chase barrier in the interior of the dispenser housing are designed and arranged to be displaceable relative to each other such that they act together as dosing elements and with each displacement travel of the housing halves only one tablet at a time reaches the dispensing area of the dispensing opening.

2. A tablet dispenser according to claim 1, wherein the dead storage barrier is arranged as far up to the front side of the dispenser housing located at the dispensing side such that its wider back abuts the front wall of the housing bottom part in the starting position of the dispenser.

3. A tablet dispenser according claim 1, wherein the dead storage barrier in the housing interior located at the corner of the dispenser housing opposite the dispensing opening is dimensioned such that it at least partially fills the space between the chase barrier and the side wall of the housing bottom part at the dispensing side in a starting position of the tablet dispenser and is displaced in a dispensing position of the tablet dispenser such that it closes off the space between the chase barrier and the side wall of the housing bottom part at the dispensing side to the front with its lower edge and thus prevents any possible trail of tablets around the front of the chase barrier.

4. A tablet dispenser according to claim 1, wherein for flat tablets whose thickness is substantially smaller than the housing depth so that two or more tablets can lie on top of each other, an additional ramp-like dosing element is mounted on the housing bottom part for pre-dosing the tablets in the interior of the dispenser housing in the intake area toward the dispensing opening.

5. A tablet dispenser according to claim 4, wherein the ramp-like dosing element is concavely shaped from the bottom side of the housing bottom part with webs arranged in this cavity for the stabilizing thereof.

6. A tablet dispenser according to claim 1, wherein the front wall of the housing bottom part located at the dispensing side exhibits a recess whose width is smaller than the tablet diameter and corresponds to the width of the wide back of the chase barrier and which is closed by means of the inserted wide back of the chase barrier in a closed tablet dispenser.

7. A tablet dispenser according to claim 1, wherein a cam is arranged on the inside top surface of housing top part which restricts the displacement of the housing top part during the dispensing of tablets by abutting the rear front wall of the housing bottom part opposite the dispensing opening.

8. A tablet dispenser according to claim 1, wherein an arched web is arranged on the inside top surface of the top part next to the chase barrier, which by contacting the dead storage barrier, hampers the unintentional opening and closing of the tablet dispenser and which signals the opening and closing acoustically and/or with a tactile sensation.

9. A tablet dispenser according to claim 1, wherein a repositioning device with a spring element is arranged in the area of the housing top part opposite the dispensing opening which supports itself at the rear front wall of the housing bottom part and which is tensioned during the dispensing of tablets by the displacement of the housing top part.

10. A tablet dispenser according to claim 1, wherein the front wall of the top part opposite the dispensing opening exhibits a recess in order to facilitate the displacement of the housing halves from the outside.

11. A tablet dispenser according to claim 1, wherein the dosing elements are manufactured as segments in one piece with the housing halves.

12. A tablet dispenser according to claim 1, wherein both housing halves of the dispenser housing are connected to each other at both of their longitudinal side walls by means of a detachable locking mechanism, for example by a clip lock.

13. A tablet dispenser according to claim 1, wherein it is designed to be refilled following emptying.
